(19) United States
(12) Patent Application Publication
(10) Pub. No.: US 2005/0248916 A1
(43) Pub. Date: Nov. 10, 2005

(54) External disk drive/optical disk device with illumination for computers

(76) Inventor: Cheng Yu Huang, Taipei (TW)

Correspondence Address: TROXELL LAW OFFICE PLLC;SUITE 1404, 5205 LEESBURG PIKE, FALLS CHURCH, VA, 22041, US

(21) Appl. No.: 10/851,171

(22) Filed: May 24, 2004

(30) Foreign Application Priority Data
May 4, 2004 (TW) 093206910

(51) Int. Cl. G06F 1/16

(52) U.S. Cl. 361/685

(57) ABSTRACT

This invention uses the features of supplying power and transmitting signals of the USB, 1394 or PS2 to provide an external disk drive/optical disk device with illumination for computers for connecting a personal computer or a mobile phone via a USB, 1394 or PS2 system. The device also acts as a portable lamp anytime, in addition to being an external disk drive and optical disk drive. The present invention comprises a housing, a retainer, a circuit board, an LED illuminating member, a connecting terminal, a port, a switch, a hard disk drive or an optical disk drive, a charging battery, a side board, and a link rod; wherein the retainer contains the hard disk drive that serves as a storage medium or an optical disk drive as an audio/video medium. The retainer on the circuit board comprises a USB port and an LED illuminating member, such that the forgoing USB port is connected to a computer or a hub, and the charging battery on the retainer is charged for illumination, and the housing comes with a set of link rods that can be pulled out as a handle or opened up as a footer, and thus enhancing the convenience of the application of the invention.

### FIELD OF THE INVENTION

The present invention relates to a connection of transmission circuits through USB, 1394 or PS2 for connecting to an external floppy disk drive/optical disk device as well as providing the function of serving as a portable lamp for illumination anytime. Its structure uses a retainer for containing a hard disk drive as a storage medium or containing an optical disk device as an audio/video medium, and the circuit board on the retainer comprises a USB port and an LED luminous member, such that the USB port is connected to a computer or a hub, and the charged battery on the retainer is charged for the illumination, and its housing comes with a set of link rods for being pulled out as a handle or spread open as a footer for enhancing the convenience to the use of the present invention.

### BACKGROUND OF THE INVENTION

The major features of the popular connection systems such as the popular Universal Serial Bus (USB), Institute of Electric Electronic Engineer (IEEE) 1394 and PS2 adopted in recent years includes 4 to 6 divided wires in their electric wire; wherein a plurality of divided wires are single lines for transmitting data signals, and another plurality of divided wires for providing a low-voltage (5V) and low current (100 mA to 500 mA) power line, and at least one divided wire serves as a ground line. Thus, the connection system such as the USB, 1394 and PS2 present invention has the function of transmitting data independently while transmitting data signals and supplying power and acts as an ideal connector or docking station for related computer products.

Therefore, the major function of the foregoing USB, 1394 and PS2 connecting systems is to connect several computers or several peripherals to a main computer system through a hub port or a connecting port for providing a solution for the connection and power supply between computers and peripherals, and the socket or connector of the USB, 1394 or PS2 system is generally built in a main computer system, a portable computer or a hub, which has become an integral part of the current computer equipments.

In general, manufacturers provide an “external disk drive” to increase the data storage capacity of a main computer system or specially separate the disk drive of the main computer system for making backups or facilitating the data portability. Besides connecting to a computer, the external disk drive in the past comes with a connecting line for transmitting signals only. Therefore, it is necessary to have a transformer for supplying direct current power to drive the operation of the disk drive. However, after the foregoing USB, 1394 and PS2 connecting systems are introduced, the problems of transmitting signals and supplying power are solved at the same time.

Further, the integration of an audio/video device such as a CD/VCD/DVD optical disk with a computer provides the audio/video effect and function, and the general optical disk devices are installed onto a disk drive rack. The present invention provides an external connection to a disk drive/optical disk device for its use, portability and illumination function.

In general, when nighttime arrives, the earth is in the dark. Although the present power supply and illumination equipment are perfect, yet once when the night falls, or even in the occasion when the natural lighting is insufficient in the daytime, or power disconnection caused by sudden power failure or fire, the environment turns into dark immediately. In general, people will act with confusion and cannot find their required illumination objects when the environment turns into dark all in a sudden, even if they have prepared a flash light or battery.

The foregoing computer transmission lines include a power line and a signal line, while having the features of supplying power and transmitting signals. Such arrangement can create different practical products, and thus the inventor of this invention uses the foregoing transmission line that carries electric charges to create “an external disk drive/optical disk device with illumination for computers” in accordance with this invention.

### SUMMARY OF THE INVENTION

The primary objective of the present invention is to utilize the features of transmitting USB, 1394 or PS2 signals and supplying power, and provide an external disk drive and a device having the function of a portable illuminating lamp, which uses a retainer to contain a hard disk drive that serves as a storage medium or contain an optical disk device as an audio/video medium, and the circuit board on the retainer comprises a USB port and an LED illuminating member, such that the foregoing connecting port such as the USB port is connected to a computer or a hub, and the charging battery on the retainer charges the battery for illumination, and its housing comprises a set of link rods which can be pulled out as a handle or opened up as a footer, and thus serving as a convenient and practical computer peripheral product.

The detailed description and technical characteristics of the present invention are described together with the drawings as follows.

### BRIEF DESCRIPTION OF THE DRAWINGS

FIG. 1 is a perspective view of the disassembled parts of an external disk drive device with illumination for computers according to the present invention.

FIG. 2 is a perspective view of the external disk drive device with illumination for computers according to the present invention.

FIG. 3 is another perspective view of the external disk drive device with illumination for computers according to the present invention.

FIG. 4 is a perspective view of an external disk drive device with illumination for computers according to another preferred embodiment of the present invention.

FIG. 5 is a perspective view of an external disk drive device with illumination for computers according to a further preferred embodiment of the present invention.

FIG. 6 is a perspective view of the disassembled parts of an external optical disk device with illumination for computers according to the present invention.

FIG. 7 is a perspective view of some of the disassembled parts of an external optical disk device with illumination for computers according to the present invention.

FIG. 8 is a perspective view of the external optical disk device with illumination for computers according to the present invention.

### DETAILED DESCRIPTION OF THE PREFERRED EMBODIMENTS

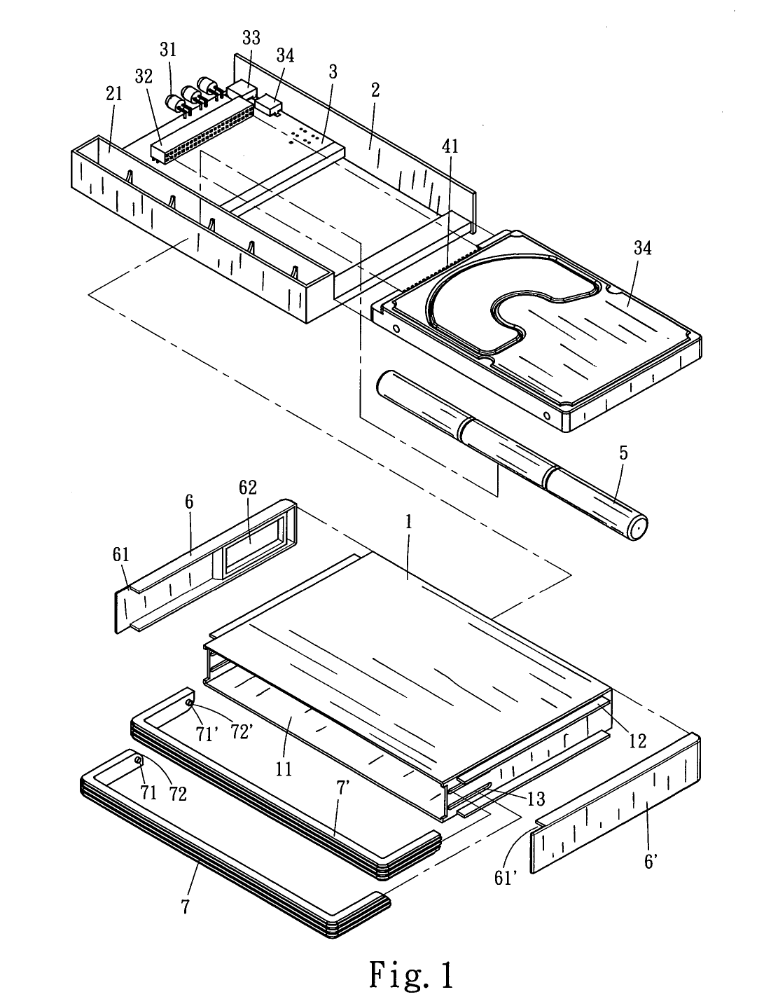

Please refer to FIG. 1 for the external disk drive/optical disk device with illumination for computers, which comprises a housing 1, a retainer 2, a circuit board 3, an LED illuminating member 31, a connecting terminal 32, a port 33, an LED switch 34, a hard disk drive 4, a charging battery 5, a side board 6 and a link rod 7; wherein the hard disk drive 4 mounted onto the retainer 2 can be substituted by the optical disk device 8.

The housing 1 according to the present invention comprises a hollow section 11 disposed in the middle, an open end disposed on both ends a symmetric flange 12 disposed on both lateral sides two slots 13 reserved on a side wall of the lateral sides. The retainer 2 could be a retaining board disposed in the hollow section 11 of the housing 1, and a fixed battery compartment 21 is disposed on one end of the retainer 2 for charging a battery 5, and a fixed circuit board 3 is disposed on one side of the retainer 2, and the circuit board 3 comprises an LED illuminating member 31, a connecting terminal 32, a port 33 and an LED switch 34; wherein the port 33 and LED switch 34 are extended outside an end of the retainer 2.

The foregoing port 33 could be a port for the USB, 1394 or PS2 systems for connecting the related connecting wires and connectors to a main computer system, a portable computer or a hub, and the hard disk drive 4 is mounted on one side of the retainer 2. The connecting terminal 41 of the hard disk drive 4 is connected to the connecting ends 32 of the foregoing circuit board 3.

Please refer to FIG. 1. A set of symmetric “n”-shaped link rods 77, 77′ disposed at the flange 12 on both outer sides of the housing 1 is placed inside the housing 1, and the inner edge of the protruded rod 71, 71′ is inserted into the slot 13, such that the link rod 77′ is pushed towards or pulled away from the housing 1, and the edges of the link rod 77 are a pair of symmetrical arcs 72, 72′, so that when the link rod 77′ is pulled out, it is opened up on both sides and serves as an erected footer.

A pair of symmetric side boards 66′ disposed outside the flange 12 on both outer side of the housing 1 covers the flange 12 on both sides of the housing 1 is inserted to cover the flange 12 on both sides of the housing 1 and an end of the link rods 7, 7′. An opening 61, 61′ is reserved at one end of the side board 66′ proximate to the link rods 7, 7′ for avoiding the space occupied by the link rods 7, 7′; wherein a light refraction window 62 is set on a side board 6 corresponding to the LED illuminating member 31 for receiving the LED illuminating member 31 and producing a refraction effect.

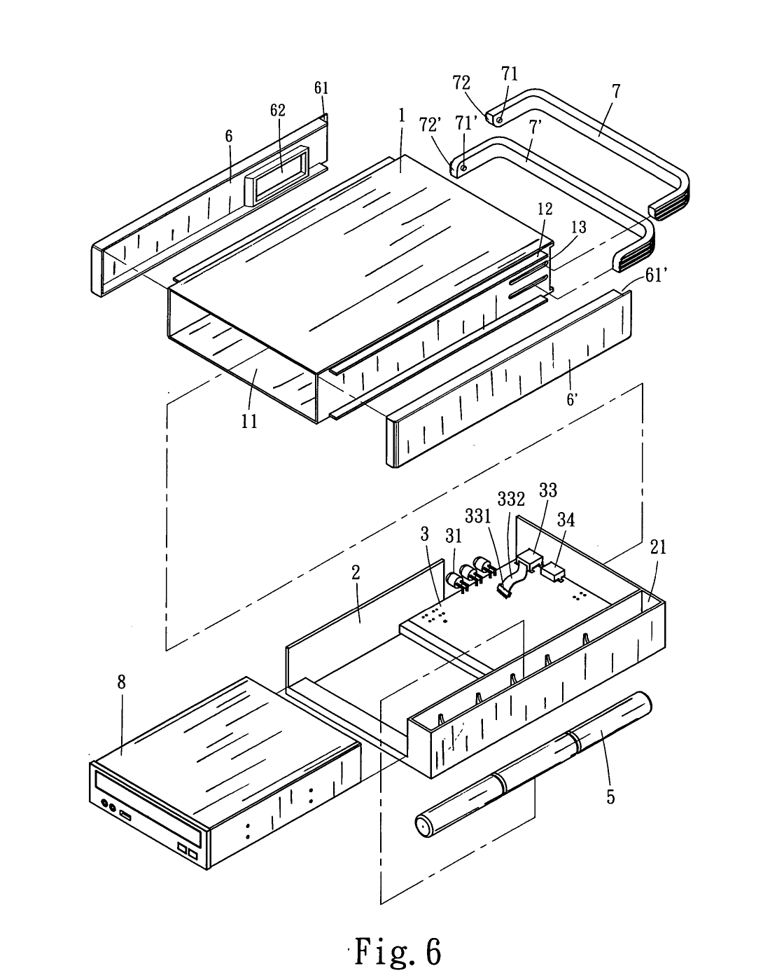

Please refer to FIGS. 6 and 7. The way of mounting the hard disk drive 4 onto the retainer 2 can be used to mount the optical disk device 8 onto the retainer 2; wherein the port 33 on the circuit board 3 is connected to a parallel cable 332 of a connecting terminal 331, so that the connecting port 33 is connected to the optical disk device 8 for the connection of an external optical disk device with illumination for computers.

In summation of the description above, the invention provides a connection for USB, 1394 or PS2 transmission circuits, which serves as a portable lamp for illumination in addition to a portable external disk drive or optical disk device.

The foregoing USB port 33 is provided for inputting a USB input power signal for charging the power supply of a battery 5 and providing the illumination function of a flashlight anytime. When the USB port 33 is in use, the 1394 or PS2 input port can be used such that such port can be used for the related transmission system.

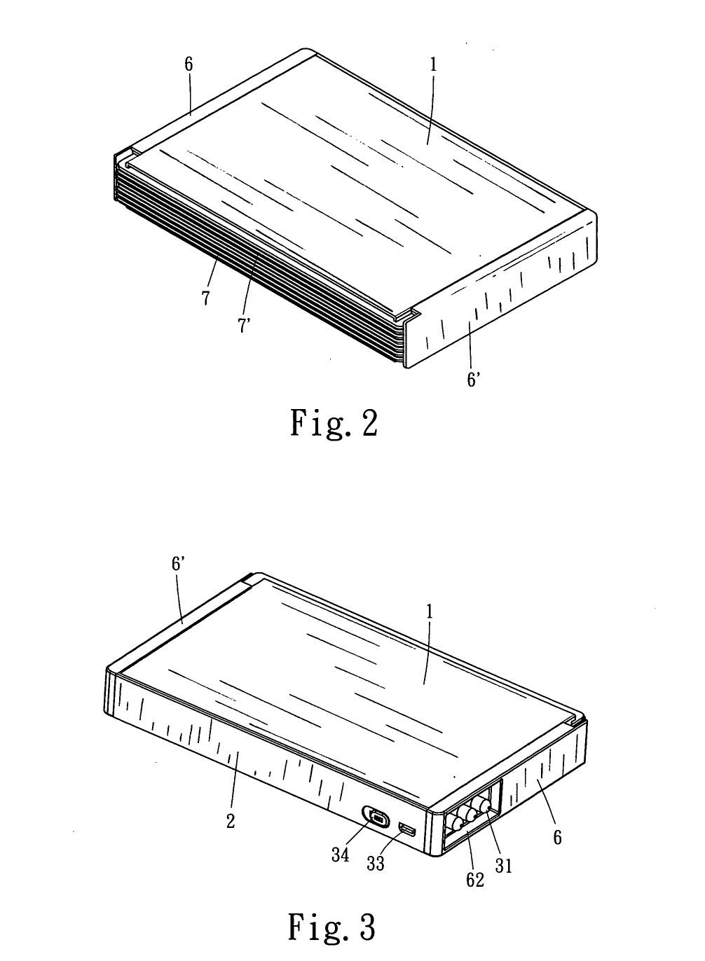

Please refer to FIGS. 2, 3 and 8 for the external disk drive/optical disk device with illumination for computer according to the present invention. If the link rod 7, 7′ is pushed inside towards the housing 1, the rod 7, 7′ can be placed flat on the desk or put inside the bag for an easy carrying.

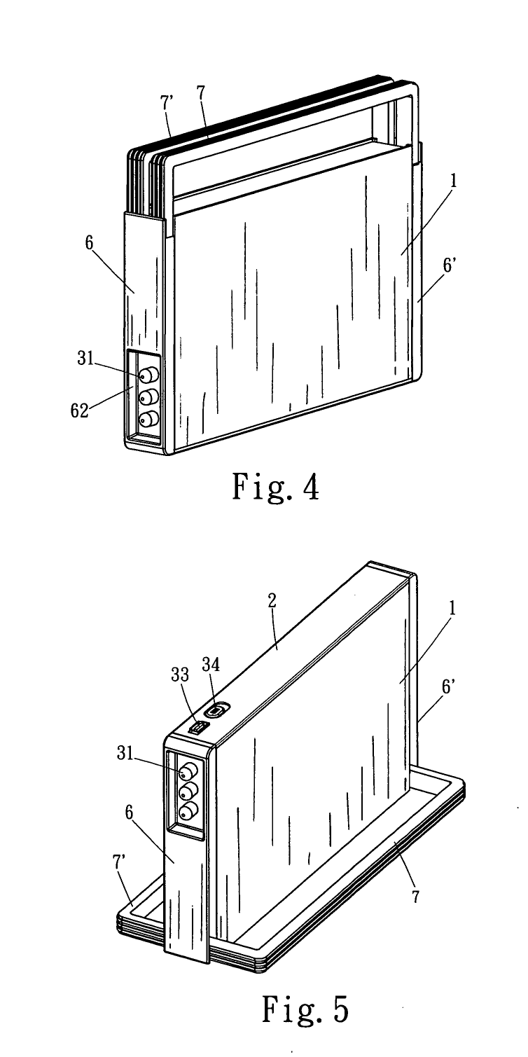

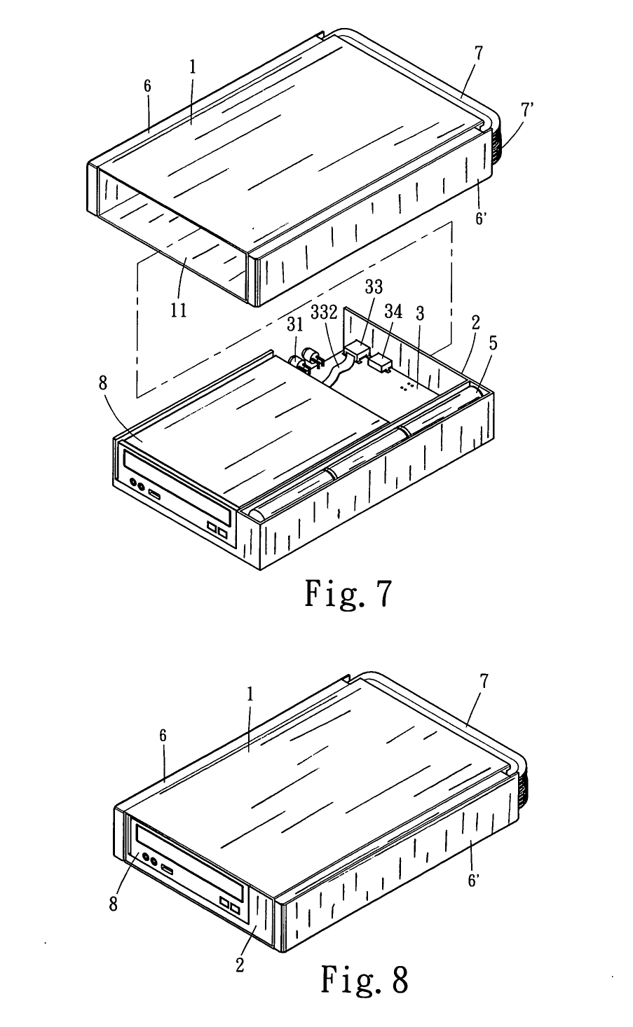

Please refer to FIGS. 4 and 8 for the external disk drive/optical disk device with illumination according to another preferred embodiment of the invention. When the link rod 7, 7′ is pulled out, the link rod 7, 7′ becomes a handle for carrying the device by hand or acts as a portable illumination equipment.

Please refer to FIG. 5 for the external disk drive/optical disk device with illumination according to another preferred embodiment of the invention. In the external disk drive/optical disk device with illumination for computers according to the present invention, the link rods 7, 7′ are opened up towards both sides to form footers for being erected on a table after the link rod 7, 7′ is pulled out.

In summation of the description above, the present invention provides a function of being a portable illuminating flashlight anytime in addition to acting as an external disk drive and optical device. Further, the housing 1 has a set of link rods that can be pulled out to serve as a handle or opened up to serve as a footer, such that the external disk drive/optical disk device with illumination can be placed flat on a table for its use, and facilitate its being carried in a bag for being used as a portable illumination equipment or opened up to be erected on a desk for its use.

While the invention has been described by way of example and in terms of a preferred embodiment, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

1. An external disk drive/optical disk device with illumination for computers, comprising a housing, a retainer, a circuit board, an LED illuminating body, a connecting terminal, a port, an LED switch, a hard disk drive, a charging battery, a side board and a link rod; characterized in that:
a USB transmission circuit being used for coupling and said retainer for containing said hard disk as a storage medium; said circuit board on said retainer comprising a USB port, said LED illuminating member and said LED switch; said port being selectively coupled to a computer and a hub; and said charging battery disposed on said retainer being charged for providing illumination.

2. The external disk drive/optical disk device with illumination for computers of claim 1, wherein said port is selected from the collection of a USB port, a 1394 port and a PS2 port for being used in an appropriate related transmission system.

3. The external disk drive/optical disk device with illumination for computers of claim 1, wherein said housing on both outer sides receives a set of symmetric “n”-shaped link, and a protruded rod disposed at the inner edge inserts into a longitudinal slot, such that said link rod is selectively. pushed into and pulled out from said housing, and the edges of said link rod are symmetric arcs such that said link rod acts as an erected footer when being opened up on both sides.

4. The external disk drive/optical disk device with illumination for computers of claim 1, wherein said hard disk drive mounted on said retainer is substituted by an optical disk drive mounted on said retainer; wherein a parallel cable with a connecting terminal is coupled to said port of said circuit board, so that said port is coupled to said optical disk drive, and thus constituting an external optical disk drive with illumination for computers.
